(19) United States
(12) Patent Application Publication
(10) Pub. No.: US 2009/0311606 A1
(43) Pub. Date: Dec. 17, 2009

(54) NEGATIVE ELECTRODE MATERIAL, MAKING METHOD, LITHIUM ION SECONDARY BATTERY, AND ELECTROCHEMICAL CAPACITOR

(76) Inventors: Hirofumi FUKUOKA, Annaka-shi (JP); Koichiro Watanabe, Annaka-shi (JP); Meguru Kashida, Annaka-shi (JP); Satoru Miyawaki, Annaka-shi (JP); Toshio Ohba, Annaka-shi (JP)

Correspondence Address: BIRCH STEWART KOLASCH & BIRCH, PO BOX 747, FALLS CHURCH, VA, 22040-0747, US

(21) Appl. No.: 12/484,898

(22) Filed: Jun. 15, 2009

(30) Foreign Application Priority Data
Jun. 16, 2008 (JP) 2008-156670

(51) Int. Cl. H01M 4/58; H01G 9/04

(52) U.S. Cl. 429/231.95; 427/78; 361/508

(57) ABSTRACT

A conductive powder is provided in which particles having silicon crystallites dispersed in a silicon compound are coated on their surface with carbon. The conductive powder develops a diffraction peak assigned to Si(111) around 2θ=28.4° on x-ray diffractometry (Cu—Kα) using copper as the counter cathode, the peak having a half width of at least 1.0°, and has a specific resistance of up to 50 mΩ. The powder is used as a negative electrode material to construct a non-aqueous electrolyte secondary battery, which has a high charge/discharge capacity and improved cycle performance.

### CROSS-REFERENCE TO RELATED APPLICATION

This non-provisional application claims priority under 35 U.S.C. §119(a) on Patent Application No. 2008-156670 filed in Japan on Jun. 16, 2008, the entire contents of which are hereby incorporated by reference.

### TECHNICAL FIELD

This invention relates to non-aqueous electrolyte secondary batteries, typically lithium ion secondary batteries, and electrochemical capacitors. Specifically, it relates to a negative electrode material for use in such batteries which provides lithium ion secondary batteries with a high charge/discharge capacity and good cycle performance, and a method for preparing the same.

### BACKGROUND ART

With the recent rapid progress of potable electronic equipment and communication equipment, secondary batteries having a high energy density are strongly desired from the standpoints of economy and size and weight reduction. Prior art known attempts for increasing the capacity of such secondary batteries include the use as the negative electrode material of oxides of V, Si, B, Zr, Sn or the like or compound oxides thereof (JP-A 5-174818, JP-A 6-60867), melt quenched metal oxides (JP-A 10-294112), silicon oxide (Japanese Patent No. 2997741), and Si₂N₂O or Ge₂N₂O (JP-A 11-102705). Other known approaches taken for the purpose of imparting conductivity to the negative electrode material include mechanical alloying of SiO with graphite followed by carbonization (JP-A 2000-243396), coating of silicon particle surfaces with a carbon layer by chemical vapor deposition (JP-A 2000-215887), and coating of silicon oxide particle surfaces with a carbon layer by chemical vapor deposition (JP-A 2002-42806).

These prior art methods are successful in increasing the charge/discharge capacity and the energy density of secondary batteries, but fall short of the market demand partially because of unsatisfactory cycle performance. There is a demand for further improvement in energy density.

More particularly, Japanese Patent No. 2997741 describes a high capacity electrode using silicon oxide as the negative electrode material in a lithium ion secondary cell. As long as the present inventors have empirically confirmed, the performance of this cell is yet unsatisfactory due to an increased irreversible capacity on the first charge/discharge cycle and a practically unacceptable level of cycle performance. With respect to the technique of imparting conductivity to the negative electrode material, JP-A 2000-243396 provides insufficient conductivity since a uniform carbon coating is not formed due to solid-solid fusion. JP-A 2000-215887 is successful in forming a uniform carbon coating, but the negative electrode material based on silicon experiences extraordinary expansion and contraction upon absorption and desorption of lithium ions and as a result, fails to withstand practical service. At the same time, the cycle performance declines, and the charge/discharge quantity must be limited in order to prevent such decline. In JP-A 2002-42806, an improvement in cycle performance is ascertainable, but the capacity gradually decreases with the repetition of charge/discharge cycles and suddenly drops after a certain number of cycles, because of precipitation of silicon micro-crystals, the under-developed structure of the carbon coating and insufficient fusion of the carbon coating to the substrate. This negative electrode material is yet insufficient for use in secondary batteries.

Citation List
Patent Document 1: JP-A 5-174818
Patent Document 2: JP-A 6-60867
Patent Document 3: JP-A 10-294112
Patent Document 4: JP 2997741
Patent Document 5: JP-A 11-102705
Patent Document 6: JP-A 2000-243396
Patent Document 7: JP-A 2000-215887
Patent Document 8: JP-A 2002-42806
Patent Document 9: JP 3952180 (U.S. Pat. No. 7,037,581, CN 1513922A)

### SUMMARY OF THE INVENTION

An object of the invention is to provide a negative electrode material for use in non-aqueous electrolyte secondary batteries, especially lithium ion secondary batteries, which provides them with a high charge/discharge capacity and good cycle performance, and a method for preparing the same. Another object is to provide a lithium ion secondary battery and an electrochemical capacitor using the same.

The inventors discovered that significant improvements in battery characteristics are achievable by covering surfaces of particles having silicon crystallites dispersed in a silicon compound with carbon, but a simple carbon coating is insufficient to achieve a high charge/discharge capacity and good cycle performance required of the lithium ion secondary batteries. Continuing research efforts, the inventors have found that the required level of battery performance can be met when a conductive powder having physical properties within a certain range in which particles of the structure that silicon crystallites are dispersed in a silicon compound are coated on their surface with a carbon coating is used as a negative electrode material for non-aqueous electrolyte secondary batteries.

In the course of research work, the inventors made a test for evaluating the battery characteristics of a series of conductive powders in which particles comprising silicon crystallites dispersed in a silicon compound are coated on their surface with a carbon coating under different sets of conditions, and found that the battery characteristics differ with different powders. An analysis on these materials revealed an apparent correlation of battery performance to the crystallinity of silicon and the conductivity of powder. It has been found that by limiting these factors within certain ranges, a negative electrode material having improved battery performance is obtainable. Based on this finding, a method for preparing the negative electrode material has been established.

In one aspect, the invention provides a negative electrode material for non-aqueous electrolyte secondary batteries, comprising a conductive powder of particles of the structure that crystallites of silicon are dispersed in a silicon compound, the particles being coated on their surface with a carbon coating. The conductive powder develops a diffraction peak assigned to Si(111) around 2θ=28.4° on x-ray diffractometry (Cu—Kα) using copper as the counter cathode, the peak having a half width of at least 1.0°, and has a specific resistance of up to 50 mΩ.

In a preferred embodiment, the conductive powder has an average particle size of 0.1 to 30 μm and a BET specific surface area of 0.5 to 30 m²/g. Typically, the silicon compound is silicon dioxide.

In another aspect, the invention provides a method for preparing the negative electrode material defined above, the method comprising the step of effecting chemical vapor deposition on silicon oxide particles of the general formula: SiOx wherein 1.0≦x<1.6, in an organic gas and/or vapor at a reduced pressure of 50 to 30,000 Pa and a temperature of 700° C. to less than 950° C., thereby coating the silicon oxide particles on their surface with a carbon coating.

Further embodiments of the invention include a lithium ion secondary battery and an electrochemical capacitor, comprising the negative electrode material defined above.

### ADVANTAGEOUS EFFECTS OF INVENTION

Using the negative electrode material of the invention, a non-aqueous electrolyte secondary battery can be constructed, which exhibits a high charge/discharge capacity and improved cycle performance.

### DESCRIPTION OF EMBODIMENTS

As used herein, the term “conductive” or “conductivity” refers to electrically conductive or electric conductivity.

The negative electrode material for non-aqueous electrolyte secondary batteries according to the invention is a conductive powder of particles comprising crystallites of silicon dispersed in a silicon compound and coated on their surface with a carbon coating, characterized in that the conductive powder develops a diffraction peak assigned to Si(111) around 2θ=28.40° on x-ray diffractometry (Cu—Kα) using copper as the counter cathode, the peak having a half width of at least 1.0°, and has a specific resistance of up to 50 mΩ.

### Particles

The powder particles serving as a base of the negative electrode material according to the invention are particles of the structure that crystallites of silicon are dispersed in a silicon compound, which structure is selected in terms of charge/discharge capacity. The silicon compound is preferably inert and includes silicon dioxide, silicon nitride, silicon carbide, and silicon oxynitride, for example, with silicon dioxide being preferred for ease of preparation.

In JP 3952180 (U.S. Pat. No. 7,037,581, EP 1363341A2, CN 1513922), the Applicant already proposed: “A conductive silicon composite for use as a non-aqueous electrolyte secondary cell negative electrode material in which particles of the structure that crystallites of silicon are dispersed in a silicon compound are coated on their surface with carbon, wherein when analyzed by x-ray diffractometry, a diffraction peak attributable to Si(111) is observed, and the silicon crystallites have a size of 1 to 500 nm as determined from the half width of the diffraction peak by Scherrer method.” This conductive silicon composite is usually prepared by disproportionating silicon oxide with an organic gas and/or vapor at a temperature of 900 to 1,400° C. under atmospheric pressure. It differs from the conductive powder of the present invention in that the diffraction peak usually has a half width of up to 0.8° and the powder has a specific resistance of at least 100 mΩ.

Also, in Japanese Patent Application No. 2008-027357 (U.S. Ser. No. 12/367,245, CN 200910126730.5), the Applicant proposes: “A negative electrode material for non-aqueous electrolyte secondary batteries, comprising a conductive powder of particles of a lithium ion-occluding and releasing material coated on their surface with a graphite coating, characterized in that said graphite coating, on Raman spectroscopy analysis, develops broad peaks having an intensity I₁₃₃₀ and I₁₅₈₀ at 1330 cm⁻¹ and 1580 cm⁻¹ Raman shift, an intensity ratio I₁₃₃₀/I₁₅₈₀ being 1.5<I₁₃₃₀/I₁₅₈₀<3.0.” This negative electrode material is usually prepared by effecting chemical vapor deposition in an organic gas and/or vapor under a reduced pressure of 50 Pa to 30,000 Pa and at a temperature of 1,000 to 1,400° C. on particles of a lithium ion-occluding and releasing material, thereby coating the particles on their surface with a graphite coating. It differs from the conductive powder of the present invention in that the CVD temperature is higher, the diffraction peak usually has a half width of up to 0.8° and the powder has a specific resistance of up to 50 mΩ.

Although the physical properties of particles having silicon crystallites dispersed in a silicon compound are not particularly limited, an average particle size of 0.01 to 30 μm, especially 0.1 to 10 μm is preferred. A powder with an average particle size of less than 0.01 μm may have a lower purity due to the influence of surface oxidation, and when used as the negative electrode material in a non-aqueous electrolyte secondary cell, may suffer from a lowering of charge/discharge capacity and a lowering of bulk density, and hence, a loss of charge/discharge capacity per unit volume. On a powder with an average particle size of more than 30 μm, only a reduced amount of graphite may deposit during chemical vapor deposition, and the resulting powder may lead to a loss of cycle performance when used as the negative electrode material in a lithium ion secondary cell. It is noted that the average particle size is determined as a weight average particle diameter upon measurement of particle size distribution by laser light diffractometry.

### Conductive Powder

The conductive powder consists of particles comprising silicon crystallites dispersed in a silicon compound, the particles being coated on their surface with a carbon coating. The conductive powder develops a diffraction peak assigned to Si(111) around 2θ=28.4° when analyzed by x-ray diffractometry (Cu—Kα) using copper as the counter cathode, the peak having a half width of at least 1.0°, preferably 1.2° to 3.0°, and has a specific resistance of up to 50 milliohms (mΩ), preferably 5 to 30 mΩ. It is critical for the invention that the diffraction peak half width be equal to or more than 1.0° and the powder specific resistance be equal to or less than 50 mΩ. If the half width is less than 1.0°, then the powder contains silicon of higher crystallinity, which may lead to a low battery capacity when used as the negative electrode material in a lithium ion secondary battery. A powder with a specific resistance of more than 50 mΩ may lead to a low battery capacity and poor cycle performance when used as the negative electrode material in a non-aqueous electrolyte secondary battery.

Although other physical properties of the conductive powder are not particularly limited, an average particle size of 0.1 to 30 μm, especially 0.3 to 20 μm is preferred. A powder having an average particle size of too small may be difficult to prepare and have a larger specific surface area and hence, a higher proportion of silicon oxide available on particle surfaces, which may lead to a low battery capacity when used as the negative electrode material in a non-aqueous electrolyte secondary battery. If the average particle size is more than 30 μm, such particles may become foreign particles when coated on an electrode, leading to substantial drops of battery characteristics. It is noted that the average particle size is determined as a weight average particle diameter upon measurement of particle size distribution by laser light diffractometry. The conductive powder should preferably have a specific surface area of 0.5 to 30 m²/g, and more preferably 1 to 20 m²/g, as measured by the BET method. If the surface area is less than 0.5 m²/g, such particles may be weakly anchored when coated on an electrode, leading to a decline of battery characteristics. A powder with a surface area of more than 30 m²/g may have a higher proportion of silicon oxide available on particle surfaces, which may lead to a low battery capacity when used as the negative electrode material in a non-aqueous electrolyte secondary battery.

The conductive powder having properties as described above may be prepared, for example, by effecting chemical vapor deposition (CVD) on silicon oxide particles of the general formula: SiOx wherein 1.0≦x<1.6, in an organic matter gas and/or vapor at a reduced pressure of 50 Pa to 30,000 Pa and a temperature of 700° C. to less than 950° C. Through this treatment, CVD and disproportionation of silicon oxide occur at the same time, so that silicon oxide particles assume the structure that silicon crystallites are dispersed in a silicon compound and the particles are coated on their surface with a carbon coating. As a result, the powder becomes conductive and have the properties described above. These properties are ascertainable, on x-ray diffractometry (Cu—Kα) analysis using copper as the counter cathode, by a diffraction peak assigned to Si(111) around 2θ=28.4°.

As used herein, the term “silicon oxide” generally refers to amorphous silicon oxides obtained by heating a mixture of silicon dioxide and metallic silicon to produce a silicon monoxide gas and cooling the gas for precipitation. The silicon oxide used herein is represented by the general formula: SiOx wherein x is 1.0≦x<1.6. Herein x is preferably 1.0≦x<1.3, and more preferably 1.0≦x≦1.2.

Silicon oxide particles preferably have an average particle size of at least 0.1 μm, more preferably at least 0.3 μm, even more preferably at least 0.5 μm. The upper limit of average particle size is preferably up to 30 μm, more preferably up to 20 μm though not critical. The silicon oxide powder preferably has a BET specific surface area of at least 0.1 m²/g, more preferably at least 0.2 m²/g. The upper limit of specific surface area is preferably up to 30 m²/g, more preferably up to 20 m²/g though not critical. If the average particle size and BET surface area of silicon oxide particles are outside the ranges, a conductive powder having the desired average particle size and BET surface area may not be obtained.

The pressure during the treatment is 50 Pa to 30,000 Pa, preferably 100 Pa to 25,000 Pa, and more preferably 1,000 Pa to 20,000 Pa. It is critical for the invention that the CVD treatment be conducted at a pressure and temperature in the specific ranges. CVD treatment under a reduced pressure enables uniform coverage of particles with carbon, which ensures that the conductive powder having a significantly improved conductivity provides an improved battery capacity when used as the negative electrode material in a non-aqueous electrolyte secondary battery. If the reduced pressure is lower than 50 Pa, a pump having an excessively high vacuum capacity must be installed, leading to increased system and running costs, despite non-perceivable improvements in battery characteristics. If the reduced pressure is higher than 30,000 Pa, the resulting powder may become less conductive and have a higher specific resistance, leading to a low battery capacity when used as the negative electrode material in a non-aqueous electrolyte secondary battery.

In the invention, the treatment temperature is also crucial and in the range of 700° C. to less than 950° C., and preferably 750° C. to 925° C. As long as the treatment temperature is in this range, cycle performance can be improved. If treatment is at or above 950° C., the half width of an x-ray diffraction curve peak around 2θ=28.4° is less than 1.0°, indicating a loss of cycle performance. The treatment time varies depending on other factors including the desired carbon coverage, the treatment temperature, the concentration and flow rate of organic matter gas, although a time of about 1 to 10 hours, especially about 2 to 7 hours is usually recommended for economy and efficiency. The preparation method is simple enough to lend itself to a commercial scale of production.

In the practice of the invention, the organic material to generate the organic gas is selected from those materials capable of producing carbon (graphite) through pyrolysis at the heat treatment temperature, especially in a non-oxidizing atmosphere. Exemplary are hydrocarbons such as methane, ethane, ethylene, acetylene, propane, butane, butene, pentane, isobutane, and hexane alone or in admixture of any, and monocyclic to tricyclic aromatic hydrocarbons such as benzene, toluene, xylene, styrene, ethylbenzene, diphenylmethane, naphthalene, phenol, cresol, nitrobenzene, chlorobenzene, indene, coumarone, pyridine, anthracene, and phenanthrene alone or in admixture of any. Also, gas light oil, creosote oil and anthracene oil obtained from the tar distillation step are useful as well as naphtha cracked tar oil, alone or in admixture.

Preferably, the amount of carbon coated or deposited on silicon oxide particles, simply referred to as “carbon coverage,” is 0.3 to 40% by weight and more preferably 0.5 to 30% by weight based on the weight of the particles comprising silicon crystallites dispersed in a silicon compound. With a carbon coverage of less than 0.3% by weight, the powder may be less conductive and provide unsatisfactory cycle performance when used as the negative electrode material in a non-aqueous electrolyte secondary battery. A carbon coverage of more than 40% by weight may achieve no further effect and indicates a too high carbon content in the negative electrode, which may reduce the charge/discharge capacity when used as the negative electrode material in a non-aqueous electrolyte secondary battery.

### Negative Electrode Material

According to the invention, the conductive powder may be used as a negative electrode material to construct a non-aqueous electrolyte secondary battery. Contemplated herein is a negative electrode material for non-aqueous electrolyte secondary batteries comprising the conductive powder described above. The negative electrode material is used to prepare a negative electrode, which is used to construct a lithium ion secondary battery.

When a negative electrode is prepared using the inventive negative electrode material, a conductive agent such as graphite may be added to the conductive powder. The type of conductive agent used herein is not particularly limited as long as it is an electronically conductive material which does not undergo decomposition or alteration in the battery. Illustrative conductive agents include metals in powder or fiber form such as Al, Ti, Fe, Ni, Cu, Zn, Ag, Sn and Si, natural graphite, synthetic graphite, various coke powders, meso-phase carbon, vapor phase grown carbon fibers, pitch base carbon fibers, PAN base carbon fibers, and graphite obtained by firing various resins.

The negative electrode may be prepared, for example, as a shaped body by the following method. The conductive powder and optional additives such as a conductive agent and binder are kneaded in a solvent such as N-methylpyrrolidone or water to form a paste mix, which is applied to a sheet as a current collector. The current collector used herein may be of any materials commonly used as the negative electrode current collector such as copper and nickel foils while it is not particularly limited in thickness and surface treatment. The technique of shaping the mix into a sheet is not particularly limited and any well-known techniques may be used.

### Lithium Ion Secondary Battery

The lithium ion secondary battery is characterized by the use of the negative electrode material while the materials of the positive electrode, negative electrode, electrolyte, and separator and the battery design may be well-known ones and are not particularly limited. For example, the positive electrode active material used herein may be selected from transition metal oxides such as LiCoO₂, LiNiO₂, LiMn₂O₄, V₂O₅, MnO₂, TiS₂ and MoS₂, lithium, and chalcogen compounds. The electrolytes used herein may be lithium salts such as lithium hexafluorophosphate and lithium perchlorate in non-aqueous solution form. Examples of the non-aqueous solvent include propylene carbonate, ethylene carbonate, diethyl carbonate, dimethoxyethane, γ-butyrolactone and 2-methyltetrahydrofuran, alone or in admixture. Use may also be made of other various non-aqueous electrolytes and solid electrolytes.

### Electrochemical Capacitor

A further embodiment is an electrochemical capacitor which is characterized by comprising the negative electrode material described above, while other materials such as electrolyte and separator and capacitor design are not particularly limited. Examples of the electrolyte used include non-aqueous solutions of lithium salts such as lithium hexafluorophosphate, lithium perchlorate, lithium borofluoride, and lithium hexafluoroarsenate, and exexmplary non-aqueous solvents include propylene carbonate, ethylene carbonate, dimethyl carbonate, diethyl carbonate, dimethoxyethane, γ-butyrolactone, and 2-methyltetrahydrofuran, alone or a combination of two or more. Other various non-aqueous electrolytes and solid electrolytes may also be used.

### EXAMPLE

Examples of the invention are given below by way of illustration and not by way of limitation.

### Example 1

A batchwise heating furnace was charged with 300 g of silicon oxide particles of the general formula SiOx (x=1.02) having an average particle size of 8 μm. The furnace was evacuated to a pressure below 100 Pa by means of an oil sealed rotary vacuum pump while it was heated to 850° C. and held at the temperature. While CH₄ gas was fed at 2 NL/min, carbon coating treatment was carried out for 10 hours. A reduced pressure of 3,000 Pa was kept during the treatment. At the end of treatment, the furnace was cooled down, obtaining about 320 g of a black powder. The black powder was a conductive powder having a carbon coverage of 7.2% by weight based on the silicon oxide particles, in which a diffraction peak assigned to Si(111) was observed around 2θ=28.4° unlike silicon oxide, the powder consisting of particles having the structure that crystallites of silicon are dispersed in a silicon compound and coated on their surface with a carbon coating. The x-ray diffraction peak around 2θ=28.4° had a half width of 1.4°, and the powder had a specific resistance of 23 mΩ, an average particle size of 8.3 μm, and a BET specific surface area of 7.6 m²/g.

Cell test

The effectiveness of a conductive powder as a negative electrode material was evaluated by the following cell test.

To the conductive powder obtained above, 10 wt % of polyimide was added and N-methylpyrrolidone added to form a slurry. The slurry was coated onto a copper foil of 12 μm gage and dried at 80° C. for one hour. Using a roller press, the coated foil was shaped under pressure into an electrode sheet. The electrode sheet was vacuum dried at 350° C. for 1 hour, after which 2 cm² discs were punched out as the negative electrode.

A test lithium ion secondary cell was constructed using a lithium foil as the counter electrode. The electrolyte solution used was a non-aqueous electrolyte solution of lithium hexafluorophosphate in a 1/1 (by volume) mixture of ethylene carbonate and diethyl carbonate in a concentration of 1 mol/liter. The separator used was a microporous polyethylene film of 30 μm thick.

The lithium ion secondary cell thus constructed was allowed to stand overnight at room temperature. Using a secondary cell charge/discharge tester (Nagano K. K.), a charge/discharge test was carried out on the cell. Charging was conducted with a constant current flow of 0.5 mA/cm² until the voltage of the test cell reached 0 V, and after reaching 0 V, continued with a reduced current flow so that the cell voltage was kept at 0 V, and terminated when the current flow decreased below 40 μA/cm². Discharging was conducted with a constant current flow of 0.5 mA/cm² and terminated when the cell voltage rose above 2.0 V, from which a discharge capacity was determined.

By repeating the above operation, the charge/discharge test was carried out 50 cycles on the lithium ion secondary cell. The cell marked an initial charge capacity of 1,998 mAh/g, an initial discharge capacity of 1,548 mAh/g, an initial charge/discharge efficiency of 77.5%, a 50-th cycle discharge capacity of 1,520 mAh/g, and a cycle retentivity of 98% after 50 cycles, indicating a high capacity. It was a lithium ion secondary cell having improved initial charge/discharge efficiency and cycle performance.

### Example 2

A batchwise heating furnace was charged with 300 g of silicon oxide particles of the general formula SiOx (x=1.02) having an average particle size of 8 μm. The furnace was evacuated to a pressure below 100 Pa by means of an oil sealed rotary vacuum pump while it was heated to 750° C. and held at the temperature. While acetylene gas was fed at 2 NL/min, carbon coating treatment was carried out for 12 hours. A reduced pressure of 2,500 Pa was kept during the treatment. At the end of treatment, the furnace was cooled down, obtaining about 320 g of a black powder. The black powder was a conductive powder having a carbon coverage of 6.3% by weight, in which a diffraction peak assigned to Si(111) was observed around 2θ=28.4° unlike silicon oxide, the powder consisting of particles having the structure that silicon crystallites are dispersed in a silicon compound and coated on their surface with a carbon coating. The x-ray diffraction peak around 2θ=28.4° had a half width of 2.6°, and the powder had a specific resistance of 15 mΩ, an average particle size of 8.2 μm, and a BET specific surface area of 10.2 m²/g.

As in Example 1, a test lithium ion secondary cell was constructed using the conductive powder and tested for cell performance. The cell marked an initial charge capacity of 2,045 mAh/g, an initial discharge capacity of 1,570 mAh/g, an initial charge/discharge efficiency of 76.8%, a 50-th cycle discharge capacity of 1,500 mAh/g, and a cycle retentivity of 95.5% after 50 cycles, indicating a high capacity. It was a lithium ion secondary cell having improved initial charge/discharge efficiency and cycle performance.

### Comparative Example 1

About 320 g of a conductive powder was prepared as in Example 1 except that carbon coating treatment was carried out on silicon oxide particles of the general formula SiOx (x=1.02), while feeding a mixture of Ar and CH₄ at a rate of 2 and 2 NL/min, under atmospheric pressure without operating the oil sealed rotary vacuum pump. The conductive powder thus obtained had a carbon coverage of 7.5% by weight based on the silicon oxide particles. The x-ray diffraction peak around 2θ=28.4° had a half width of 1.4°, and the powder had a specific resistance of 85 mΩ, an average particle size of 8.3 μm, and a BET specific surface area of 5.4 m²/g.

As in Example 1, a test lithium ion secondary cell was constructed using the conductive powder and tested for cell performance. The cell marked an initial charge capacity of 1,910 mAh/g, an initial discharge capacity of 1,480 mAh/g, an initial charge/discharge efficiency of 77.5%, a 50-th cycle discharge capacity of 1,376 mAh/g, and a cycle retentivity of 93% after 50 cycles. This lithium ion secondary cell had inferior initial charge/discharge efficiency and cycle performance to Example 1.

### Comparative Examples 2 to 4

On the same silicon oxide powder of the formula SiOx (x=1.02) as in Example 1, carbon coating treatment was carried out under conditions: temperature, time, CH₄ flow rate, and vacuum (adjusted by the valve of the oil sealed rotary vacuum pump) shown in Table 1. The carbon coverage, x-ray diffraction peak half width, specific resistance, average particle size, and BET specific surface area of the conductive powders thus obtained are shown in Table 2.

As in Example 1, test lithium ion secondary cells were constructed using the conductive powders and tested for cell performance. The results are shown in Table 3.

TABLE 1

| | Treatment | Treatment | | |
|---|---|---|---|---|
| | temp. | time | CH₄ flow rate | Pressure |
| | (° C.) | (hr) | (NL/min) | (Pa) |
| Example 1 | 850 | 10 | 2 | 3000 |
| Example 2 | 750 | 12 | acetylene 2 | 2500 |
| Comparative | 850 | 10 | Ar/CH₄ | atmospheric |
| Example 1 | | | 2/2 | |
| Comparative | 650 | 30 | 2 | 1000 |
| Example 2 | | | | |
| Comparative | 1100 | 2 | 2 | 1000 |
| Example 3 | | | | |
| Comparative | 850 | 10 | 2 | 50000 |
| Example 4 | | | | |

TABLE 2

| | | X-ray | | | |
|---|---|---|---|---|---|
| | | diffraction | | | |
| | | peak | | Average | BET |
| | Carbon | half width | Specific | particle | surface |
| | coverage | (2θ = 28.4°) | resistance | size | area |
| | (wt %) | (°) | (mΩ) | (μm) | (m²/g) |
| Example 1 | 7.2 | 1.4 | 23 | 8.3 | 7.6 |
| Example 2 | 6.3 | 2.6 | 15 | 8.2 | 10.2 |
| Comparative | 7.5 | 1.4 | 85 | 8.3 | 5.4 |
| Example 1 | | | | | |
| Comparative | 1.1 | no peak | 500 | 8.2 | 8.5 |
| Example 2 | | | | | |
| Comparative | 7.5 | 0.8 | 28 | 8.4 | 6.4 |
| Example 3 | | | | | |
| Comparative | 7.8 | 1.4 | 65 | 8.2 | 7.0 |
| Example 4 | | | | | |

TABLE 3

| | Initial | | Initial | 50-th | |
|---|---|---|---|---|---|
| | charge | Initial | charge/ | cycle | Retentivity |
| | capacity | discharge | discharge | discharge | after |
| | (mAh/ | capacity | efficiency | capacity | 50 cycles |
| | g) | (mAh/g) | (%) | (mAh/g) | (%) |
| Example 1 | 1998 | 1548 | 77.5 | 1520 | 98 |
| Example 2 | 2045 | 1570 | 76.8 | 1500 | 95.5 |
| Comparative | 1910 | 1480 | 77.5 | 1376 | 93 |
| Example 1 | | | | | |
| Comparative | 2020 | 1550 | 76.7 | 1317 | 85 |
| Example 2 | | | | | |
| Comparative | 1950 | 1520 | 77.9 | 1429 | 94 |
| Example 3 | | | | | |
| Comparative | 1970 | 1526 | 77.5 | 1404 | 92 |
| Example 4 | | | | | |

Using the negative electrode material of the invention, a lithium ion secondary cell having a high capacity and improved cycle performance can be constructed. The method of preparing the negative electrode material is simple enough to lend itself to a commercial mass scale of manufacture.

Japanese Patent Application No. 2008-156670 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A negative electrode material for non-aqueous electrolyte secondary batteries, comprising a conductive powder of particles of the structure that crystallites of silicon are dispersed in a silicon compound, the particles being coated on their surface with a carbon coating, wherein
said conductive powder develops a diffraction peak assigned to Si(111) around 2θ=28.4° on x-ray diffractometry (Cu—Kα) using copper as the counter cathode, the peak having a half width of at least 1.0°, and has a specific resistance of up to 50 mΩ.

2. The negative electrode material of claim 1 wherein said conductive powder has an average particle size of 0.1 to 30 μm and a BET specific surface area of 0.5 to 30 m²/g.

3. The negative electrode material of claim 1 wherein the silicon compound is silicon dioxide.

4. A method for preparing the negative electrode material of claim 1, comprising the step of effecting chemical vapor deposition on silicon oxide particles of the general formula: SiOx wherein 1.0≦x<1.6, in an organic gas and/or vapor at a reduced pressure of 50 to 30,000 Pa and a temperature of 700° C. to less than 950° C., thereby coating the silicon oxide particles on their surface with a carbon coating.

5. A lithium ion secondary battery comprising the negative electrode material of claim 1.

6. An electrochemical capacitor comprising the negative electrode material of claim 1.
